(19) United States
(12) Patent Application Publication
(10) Pub. No.: US 2003/0154002 A1
(43) Pub. Date: Aug. 14, 2003

(54) Method and apparatus for aligning a cassette handler

(75) Inventors: Alan Rick Lappen, San Martin, CA (US); Keith P. Weigman, Orefield, PA (US); Ronald Vern Schauer, Gilroy, CA (US)

Correspondence Address: Applied Materials, Inc., Patent Counsel, Post Office Box 450A, Santa Clara, CA, 95052, US

(73) Assignee: Applied Materials, Inc.

(21) Appl. No.: 10/322,694

(22) Filed: Dec. 17, 2002

Related U.S. Application Data
(63) Continuation-in-part of application No. 09/294,301, filed on Apr. 19, 1999, now abandoned.

(30) Foreign Application Priority Data
Feb. 18, 2000 (TW) 89102871

(51) Int. Cl. G06F 7/00

(52) U.S. Cl. 700/218

(57) ABSTRACT

Methods and apparatuses for aligning workpiece and cassette handlers in an automated workpiece handling system are provided. The apparatus comprises an alignment pin and a frame adapted to be supported by a cassette handler support surface. The frame has first and second apertures defined by first and second alignment surfaces which are adapted to receive the alignment pin. The robot blade has a blade aperture which is defined by a blade alignment surface which is adapted to receive the alignment pin when the robot blade is positioned in a first predetermined position when the pin is received by the first aperture and the blade aperture. The blade alignment surface is further adapted to receive the alignment pin when the robot blade is positioned in a second predetermined position when the pin is received by the second aperture and the blade aperture.

### CROSS REFERENCE TO RELATED APPLICATIONS

This is a continuation-in-part application which claims priority from U.S. Application No. 09/294,301, filed Apr. 19, 1999.

### FIELD OF THE INVENTION

The present invention relates to automated workpiece handling systems, and more particularly, to methods and devices for aligning workpiece and cassette handlers in an automated workpiece handling system.

### BACKGROUND

In order to decrease contamination and to enhance throughput, semiconductor processing systems often utilize one or more robots to transfer semiconductor wafers, substrates and other workpieces between a number of different vacuum chambers which perform a variety of tasks. In one arrangement, a four-chamber dry etching system includes a robot housed in a pentagonal-shaped mainframe which serves four plasma etching chambers and a loadlock chamber mounted on the robot housing. In order to increase throughput, it has been proposed to utilize two loadlock chambers as described in U.S. Pat. No. 5,186,718. In such a two loadlock system, both loadlock chambers are loaded with full cassettes of unprocessed wafers. FIG. 1 illustrates two typical loadlock chambers LLA and LLB, each having a cassette 190 therein for holding unprocessed wafers 192 to be unloaded by a robot 194 and transferred to various processing chambers 196 attached to a mainframe 198.

The loadlock chamber LLA, for example, is a pressure-tight enclosure which is coupled to the periphery of the mainframe 198 by interlocking seals which permit the loadlock chamber to be removed and reattached to the mainframe as needed. The cassette 190 is loaded into the loadlock chamber LLA through a rear door which is closed in a pressure-tight seal. The wafers are transferred between the mainframe 198 and the loadlock chamber LLA through a passageway which may be closed by a slit valve to isolate the loadlock chamber volume from the mainframe volume.

As shown in FIG. 2, a typical cassette 190 is supported by a platform 200 of a cassette handler system 208 which includes an elevator 210 which elevates the platform 200 and the cassette 190. The platform 200 has a top surface which defines a base plane 220 on which the cassette 190 rests. As the cassette includes a plurality of “slots” 204 or wafer support locations, the elevator moves the cassette to sequentially position each of the slots with the slit valves to allow a robot blade to pass from the mainframe, through the slit valve, and to a location to “pick” or deposit a wafer in a wafer slot.

The slots 204 of the cassette may be initially loaded with as many as 25 or more unprocessed wafers or other workpieces before the cassette is loaded into the loadlock chamber LLA. After the loadlock access door is closed and sealed, the loadlock chamber is then pumped by a pump system down to the vacuum level of the mainframe 198 before the slit valve is opened. The robot 194 which is mounted in the mainframe 198 then unloads the wafers from the cassette one at a time, transferring each wafer in turn to the first processing chamber.

The robot 194 includes a robot hand or blade 206 which is moved underneath the wafer to be unloaded. Using a system controller 222, the cassette handler 208 moves the cassette 190 to a predetermined position, such as “slot base 25”. The “slot base” position is the cassette position relative to the robot blade in which the blade is preferably midway between two wafers resting in consecutive slots. For example, FIG. 2 illustrates the slot base 25 position for wafer cassette 190 which is the vertical position of the wafer cassette 190 when the robot blade 206 is midway between two wafers 230 and 232 in resting in consecutive slots 24 and 25, respectively, of the wafer cassette 190.

The robot 194 then “lifts” the wafer from the wafer slot supports supporting the wafers in the cassette 190. By “lifting,” it is meant that either the robot blade 206 is elevated or the cassette 190 is lowered by the handler mechanism 208 such that the wafer is lifted off the cassette wafer supports. The wafer may then be withdrawn from the cassette 190 through the passageway and transferred to the first processing chamber.

Once a wafer has completed its processing in the first processing chamber, that wafer is transferred to the next processing chamber (or back to a cassette) and the robot 194 unloads another wafer from the cassette 190 and transfers it to the first processing chamber. When a wafer has completed all the processing steps of the wafer processing system, and two cassettes full of wafers are loaded in the loadlocks, the robot 194 returns the processed wafer back to the cassette 190 from which it came.

Once all the wafers have been processed and returned to the cassette 190, the cassette in the loadlock chamber is removed and another full cassette of unprocessed wafers is reloaded. Alternatively, a loaded cassette may be placed in one loadlock, and an empty one in the other loadlock. Wafers are thus moved from the full cassette, processed, and then loaded into the (initially) empty cassette in the other loadlock. Once the initially empty cassette is full, the initially full cassette will be empty. The full “processed” cassette is exchanged for a full cassette of unprocessed wafers, and these are then picked from the cassette, processed, and returned to the other cassette. The movements of the robot 194 and the cassette handler 208 are controlled by the operator system controller 222 which is often implemented with a programmed workstation.

As shown in FIGS. 2 and 3, in many wafer cassettes the wafers are typically very closely spaced. For example, the spacing between the upper surface of a wafer carried on a moving blade and the lower surface of an adjacent wafer in the cassette may be as small as 0.050 inches. Thus, the wafer blade must be very thin in order to fit between wafers as cassettes are loaded or unloaded. As a consequence, it is often important in many processing systems for the cassette and the cassette handler 208 to be precisely aligned with respect to the robot blade and wafer to avoid accidental contact between either the robot blade or the wafer carried by the blade and the walls of the cassette or with other wafers held within the cassette.

However, typical prior methods for aligning the handler and cassette to the robot blade have generally been relatively imprecise, often relying upon subjective visual inspections of the clearances between the various surfaces. Some tools have been developed to assist the operator in making the necessary alignments. These tools have included special wafers, bars or reference “pucks” which are placed upon the robot blade and are then carefully moved into special slotted or pocketed receptacles which are positioned to represent the tolerance limits for the blade motions. However, many of these tools have a number of drawbacks. For example, some tools rely upon contact between the blade or a tool on the blade and the receptacle to indicate a condition of nonalignment. Such contact can be very detrimental to high precision mechanisms for moving the blade as well as the blade itself. Also, many such tools do not indicate the degree of alignment or nonalignment but merely a “go/no-go” indication of whether contact is likely.

In aligning the handler mechanism to the robot blade, one procedure attempts to orient the cassette to be as level as possible with respect to the robot blade. One tool that has been developed to assist in the leveling procedure has dual bubble levels in which one bubble level is placed on the blade and the other is placed on the cassette. The operator then attempts to match the level orientation of the blade to that of the cassette. In addition to being very subjective, such bubble tools have also often been difficult to see in the close confines of the cassette and handler mechanisms.

As a consequence of these and other deficiencies of the prior alignment procedures and tools, alignments have often tended to be not only imprecise but also inconsistent from application to application. These problems have frequently lead to the breakage or scratching of very expensive wafers and equipment as well as the generation of damaging particulates in the systems.

### SUMMARY OF THE ILLUSTRATED EMBODIMENTS

An apparatus for aligning a cassette handler to a movable robot blade for carrying a workpiece in a workpiece handing system is provided. The apparatus comprises an alignment member and a frame adapted to be supported by a cassette handler support surface in a first orientation of the frame. The frame has a first frame alignment surface adapted to receive the alignment member. The first frame alignment surface defines a first predetermined robot blade position. The robot blade has a blade alignment surface adapted to receive the alignment member when the robot blade is positioned in the first predetermined position when the member is received by the first frame alignment surface and the blade alignment surface.

In one aspect of the invention, the alignment member comprises a pin. The first frame alignment surface defines a first aperture adapted to receive the pin. The blade alignment surface defines a blade aperture adapted to receive the pin.

In another aspect of the invention, the workpiece handling system includes a robot for rotating and extending the robot blade. The first predetermined robot blade position is a robot blade workpiece drop-off position which comprises a first robot blade extension position and a first robot blade rotation position.

In yet another aspect of the invention, the first predetermined robot blade position is at a first height of the robot blade relative to the handler support surface. The frame is adapted to be supported by the cassette handler support surface in a second orientation of the frame. The first frame alignment surface further defines a second predetermined robot blade position when the frame is in the second orientation. The robot blade is positioned in the second predetermined position when the member is received by the alignment surface of the robot blade and by the first frame alignment surface in the second orientation.

In yet another aspect of the invention, the frame further has a second frame alignment surface adapted to receive the alignment member. The second frame alignment surface defines a third predetermined robot blade position. The blade alignment surface is further adapted to receive the alignment member when the robot blade is positioned in the third predetermined position when the member is received by the second frame alignment surface and the blade alignment surface.

In yet another aspect of the invention, the first and second frame alignment surfaces define first and second frame apertures. The cassette handler support surface has an axis of rotation extending orthogonally from the support surface. The frame is adapted to be supported by the support surface so that the axis of rotation extends through either the first or the second frame aperture.

In an alternative embodiment, the apparatus comprises a light source means and a frame adapted to be supported by the cassette handler support surface. The frame defines a frame aperture means adapted to permit the passage of light from the light source means through the frame aperture means. A light detector means is adapted to detect the passage of light from the light source means through the frame aperture means and the blade aperture means when the robot blade is positioned in a first predetermined position. The light detector means is further adapted to detect the passage of light from the light source means through the frame aperture means and the blade aperture means when the robot blade is positioned in a second predetermined position.

In yet another embodiment, a method of aligning a cassette handler to a movable robot blade for carrying a workpiece in a workpiece handling system is provided. The cassette handler has a support surface for supporting a workpiece cassette. A frame is placed on the cassette handler support surface in a first orientation of the frame. The frame has a first frame alignment surface which defines a first predetermined robot blade position and which is adapted to receive an alignment member.

The robot blade is positioned in a first location relative to the frame at a first height of the blade relative to the handler support surface. A first test is conducted of the alignment of the robot blade relative to the frame. This first test includes placing the alignment member in engagement with either the first frame alignment surface or the blade alignment surface. The robot blade is positioned in the first predetermined robot blade position at the first height when the alignment member is received by the first frame alignment surface and the robot blade alignment surface.

In another aspect of the invention, the frame is placed on the cassette handler support surface in a second orientation of the frame. The robot blade is positioned relative to the frame at a second height of the blade relative to the handler support surface. A second test is conducted of the alignment of the robot blade relative to the frame. The second test is comprised of placing the alignment member in engagement with either the first frame alignment surface or the blade alignment surface. The robot blade is positioned in a second predetermined robot blade position at the second height when the alignment member is received by the first frame alignment surface and the robot blade alignment surface.

In another aspect of the invention, the frame has a second frame alignment surface which defines a third predetermined robot blade position and which is adapted to receive the alignment member. The robot blade is positioned in a second location relative to the frame. A third test is conducted of the alignment of the robot blade relative to the frame. The third test comprises placing the alignment member in engagement with the second frame alignment surface or the blade alignment surface. The robot blade is positioned in the third predetermined robot blade position when the alignment member is received by the second frame alignment surface and the robot blade alignment surface.

In another aspect of the invention, the cassette handler support surface is rotated about an axis of rotation of the support surface. The axis extends orthogonally from the support surface and extends through either the first frame alignment surface or the second frame alignment surface.

There are additional aspects to the present inventions. It should therefore be understood that the preceding is merely a brief summary of some embodiments and aspects of the present inventions. Additional embodiments and aspects of the present inventions are referenced below. It should further be understood that numerous changes to the disclosed embodiments can be made without departing from the spirit or scope of the inventions. The preceding summary therefore is not meant to limit the scope of the inventions. Rather, the scope of the inventions is to be determined by appended claims and their equivalents.

### BRIEF DESCRIPTION OF THE DRAWINGS

FIG. 1 is a schematic top view of a typical deposition chamber having two loadlock chambers.

FIG. 2 is a schematic front view of a typical wafer cassette disposed on a platform of a cassette handling system.

FIG. 3 is a partial view of the wafer cassette of FIG. 2, depicting a wafer resting in a slot and a wafer picked up from a slot.

FIG. 3A is an enlarged partial view of the wafer cassette of FIG. 3, depicting a wafer resting in a slot and a wafer picked up from a slot.

FIG. 4 is a schematic pictorial view of a cassette alignment tool system in accordance with one embodiment of the present invention.

FIG. 5 is a side view of the metrology cassette of FIG. 4.

FIG. 6 is a schematic partial cross-sectional top view of the metrology cassette of FIG. 5, showing distance sensors in one configuration.

FIG. 7A is a top view of the metrology cassette of FIG. 4 illustrating an extension and rotation alignment procedure.

FIG. 7B is a side view of the metrology cassette of FIG. 4 illustrating an extension and rotation alignment procedure.

FIG. 8A is a top view of the metrology cassette of FIG. 4 illustrating an extension and rotation alignment procedure.

FIG. 8B is a side view of the metrology cassette of FIG. 4 illustrating an extension and rotation alignment procedure.

FIG. 8C is a front view of the metrology cassette of FIG. 4 illustrating insertion of an alignment pin during an extension and rotation alignment procedure.

FIG. 9A is a top view of the metrology cassette of FIG. 4 illustrating an extension and rotation alignment procedure.

FIG. 9B is a side view of the metrology cassette of FIG. 4 illustrating an extension and rotation alignment procedure.

FIG. 10A is a partial side view of the metrology cassette of FIG. 4 illustrating insertion of an alignment pin during an extension and rotation alignment procedure when the cassette is in an inverted position.

FIG. 10B is a front view of the metrology cassette of FIG. 4 illustrating insertion of an alignment pin during an extension and rotation alignment procedure when the cassette is in an inverted position.

FIG. 11 is a view of the computer display of FIG. 4, depicting an input-output screen used in an extension and rotation alignment procedure.

FIG. 12 is a view of another computer display, depicting an input-output screen used in an extension and rotation alignment procedure.

FIG. 13 is a side view of a light source and detector arrangement for a metrology cassette in accordance with another embodiment of the inventions.

### DETAILED DESCRIPTION

In the following description, reference is made to the accompanying drawings which form a part hereof and which illustrate several embodiments of the present invention. It is understood that other embodiments may be utilized and structural and operational changes may be made without departing from the scope of the present invention.

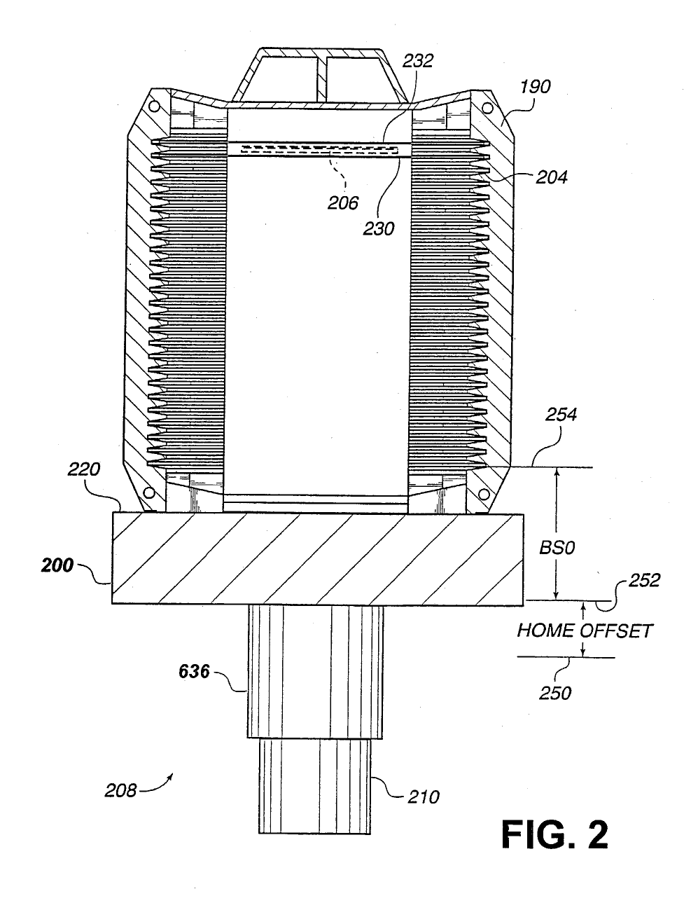

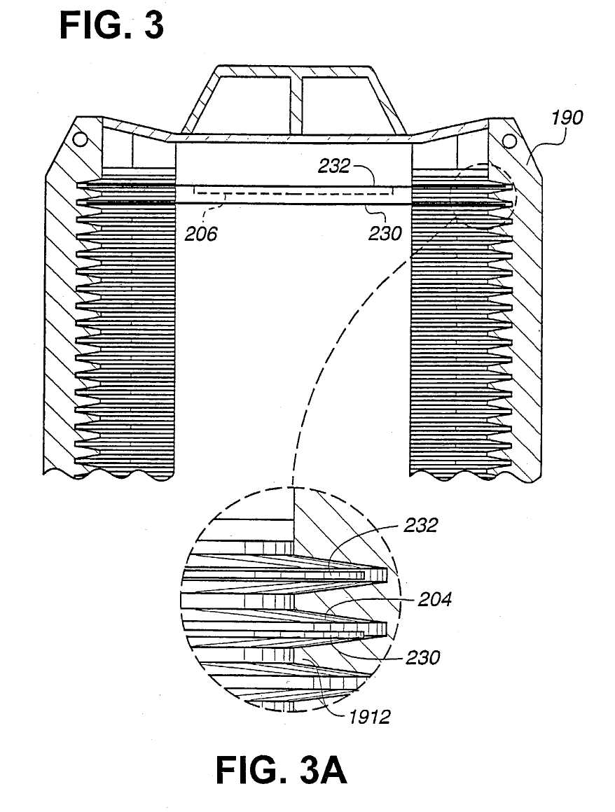

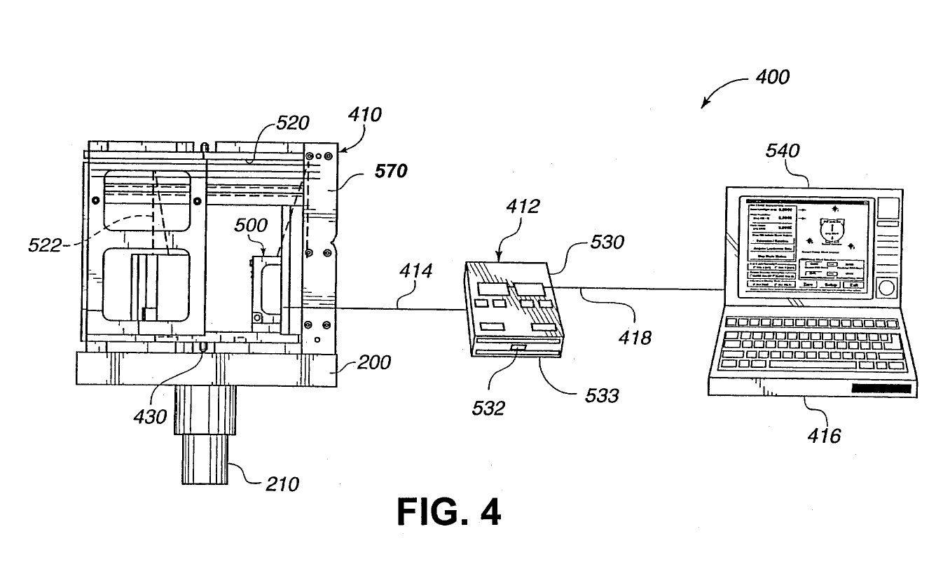

A cassette alignment tool system in accordance with one embodiment of the present invention is indicated generally at 400 in FIG. 4. The tool system 400 comprises a metrology cassette 410, cassette controller 412 coupled by a communication cable 414 to the metrology cassette 410, and a computer 416 coupled by a communication cable 418 to the cassette controller 412. The metrology cassette 410 is secured to the cassette handler platform 200 in the same manner as an actual wafer cassette such as the cassette 190 of FIG. 2 and thus emulates the wafer cassette 190. For example, the metrology cassette has alignment and registration surfaces including a bottom H-bar 430 and side rails 570 which are received by the cassette handler to align the cassette with respect to the handler. In addition, the metrology cassette 410 approximates the size and weight of a production wafer cassette full of wafers.

The cassette alignment tool system 400 may be used with processing systems having one or many processing chambers and one or more workpiece handling systems for transferring workpieces from one or more cassettes in one or more loadlock chambers to the processing chambers. Once a particular handling system has been properly aligned and calibrated to the robot blade and workpiece, the metrology cassette 410 may be removed from the handler and processing of workpieces may begin using a standard workpiece cassette which was emulated by the metrology cassette 410. However, it is preferred that all handlers of a particular processing system be properly aligned prior to initiating processing of production workpieces.

In accordance with one aspect of the illustrated embodiments, the metrology cassette 410 has a distance measurement device 500 which can provide precise measurements of the position of a wafer or other workpiece being held by the robot blade within the metrology cassette 410. As explained in greater detail below, these wafer position measurements can be used to accurately align an actual wafer cassette such as the cassette 190 to the robot blade in such a manner as to reduce or eliminate accidental contact between the blade or the wafer held by the blade and the cassette or wafers held within the wafer cassette.

### Robot Blade Extension and Rotation Alignment

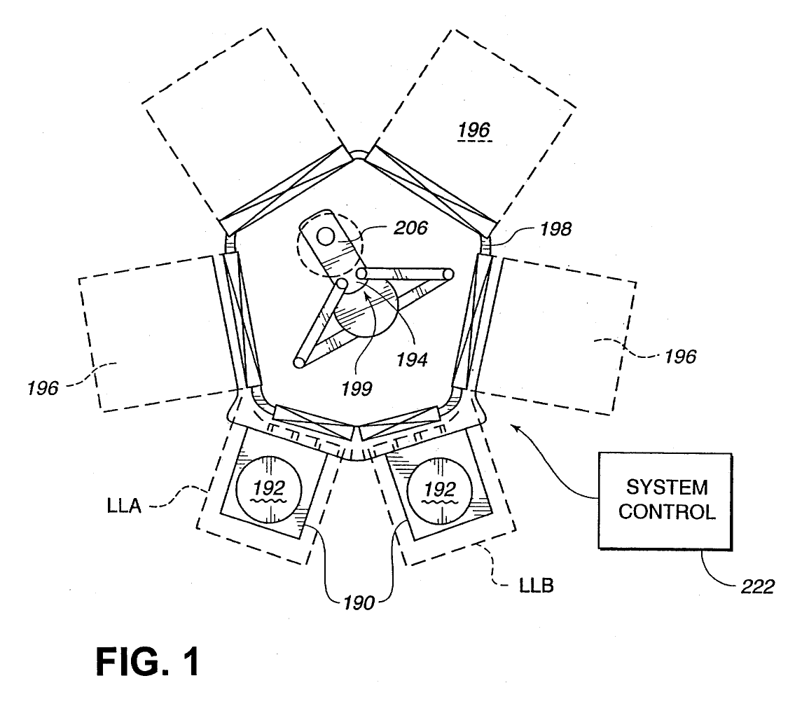

It is useful to properly set the “wafer drop” or “wafer pick” position of the wafer blade relative to the cassette and to rotationally align the cassette handler platform 200 relative to the wafer blade. The “wafer drop” position is usually the same as the “wafer pick” position and is the position at which the blade drops a wafer into a slot or picks a wafer up from a slot. In many processing systems, the transfer robot can move the wafer blade in a rotational movement centered about a pivot point 199 (FIG. 1) on the robot shoulder. In addition, the blade can be extended radially outward and withdrawn radially inward in a translational movement.

These movements, commanded through the processing system controller, can be defined in terms of a rotation count and an extension step count. Each extension step represents an incremental translation movement of the robot blade and each rotation count represents an incremental rotational movement of the blade. The system controller can cause the blade to rotate and then extend or to both rotate and extend in combined motions in response to rotation step commands and extension step commands inputted to the system controller by the operator.

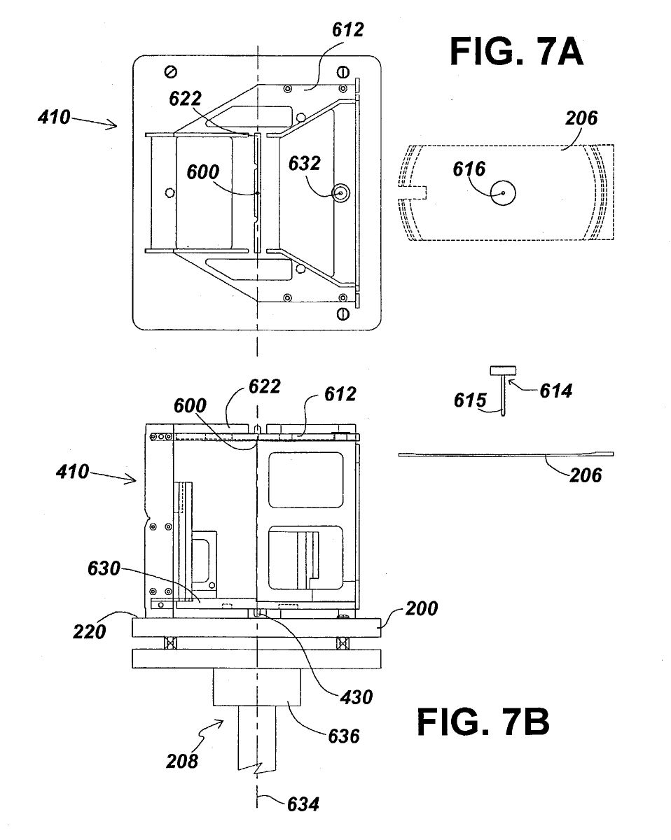

The metrology cassette 410 can be used for aligning a cassette handler to a movable robot blade. The cassette 410 is a frame structure having a top plate 612 (FIGS. 7A & 7B). The top plate 612 has first and second alignment apertures or holes 600, 632, each of which is defined by a circular or cylindrical inner alignment surface which in turn is adapted to receive an alignment member, or pin 614. The two frame alignment surfaces define first and second predetermined robot blade positions. In the illustrated embodiments, the second hole 632 can be spaced from the first hole 600 by a distance of 1.75 inches to 4.0 inches, and preferably 3.375 inches. However other distance spacings can be used for cassettes of different dimensions and designs.

The robot blade 206 has a blade alignment hole 616 defined by a circular or cylindrical inner alignment surface which also is adapted to receive the alignment pin 614. Thus the robot blade 206 is positioned in the first predetermined position when the pin 614 is received by the blade alignment surface and one of the frame alignment surfaces. Similarly, the robot blade is positioned in the second predetermined position when the pin 614 is received by the blade alignment surface and the other of the frame alignment surfaces.

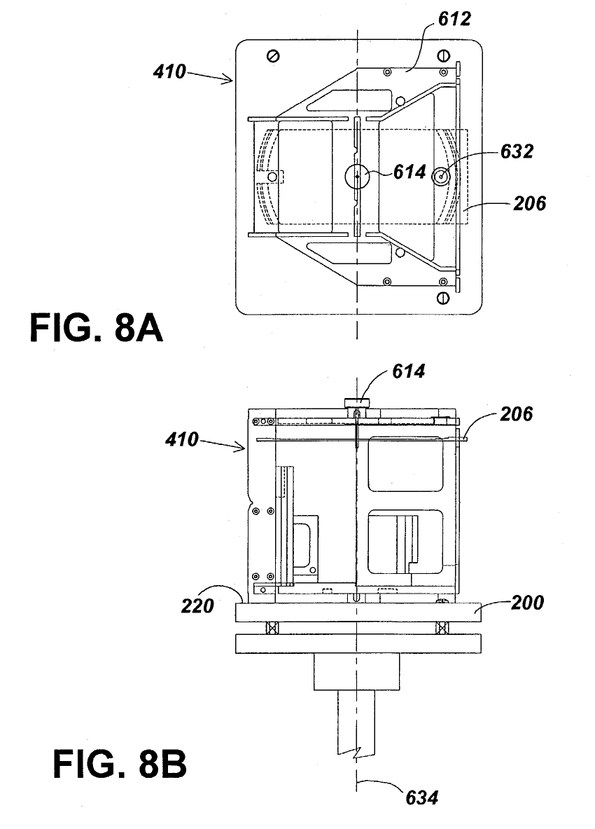

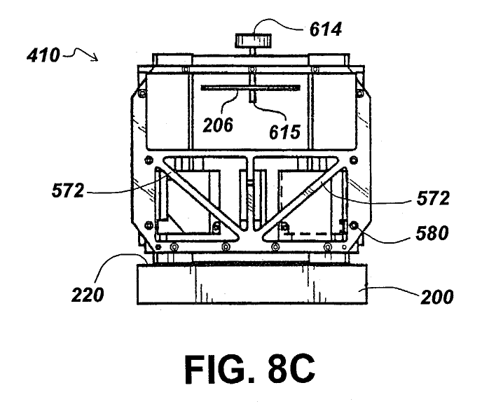

When the blade 206 is properly aligned and positioned in the drop/pickup position as shown in FIGS. 8A and 8B, the pin 614 may pass through both the first alignment hole 600 and the blade alignment hole 616. Furthermore, the cassette alignment tool system 400 can provide a graphical operator interface which facilitates the blade extension and rotation alignment procedure.

As used herein, the term “blade” refers to the robot blade 206 illustrated and discussed as well as other robot hands for holding a wafer or other semiconductor workpiece, such as a display panel substrate, which is loaded and unloaded from a cassette in a semiconductor processing system.

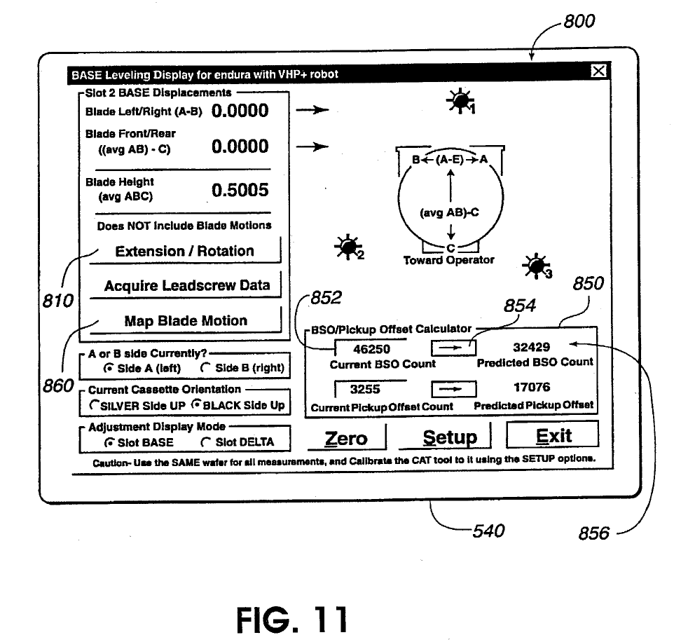

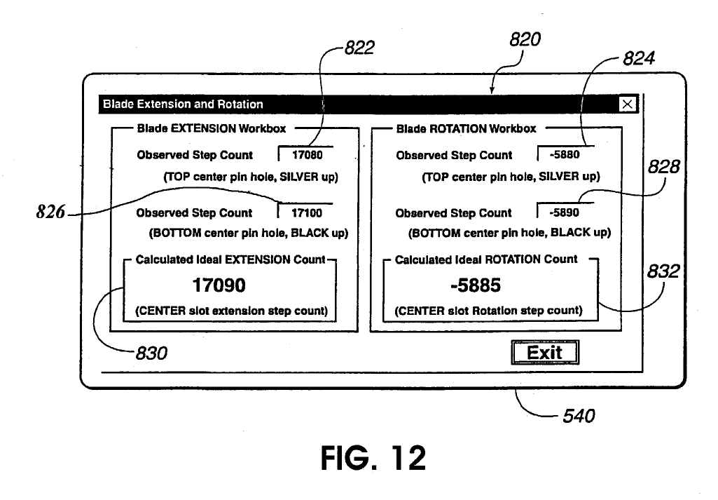

Referring now to FIG. 11, the operator may use a computer display 540 and select the “Extension/Rotation” button 810 of a Leveling Display 800 by moving the computer display cursor to the Extension/Rotation button 810 and clicking the left mouse button. A Blade Extension and Rotation worksheet 820 will appear on the computer display screen, as shown in FIG. 12.

To ready the cassette alignment tool system 400 for the rotation and extension alignment procedure, the metrology cassette 410 is placed on the cassette handler of a loadlock such as loadlock “LLA” with the top plate 612 up as shown in FIG. 7B and the cassette alignment surfaces such as the bottom H-bar 430 of the bottom plate 630 properly registered with the handler alignment surfaces of the platform 200. The operator then causes the processing system controller to move the loadlock “LLA” cassette handler to slot base #24 and then extend the robot blade 206 to the Drop Position/Pick Position of loadlock “LLA” as shown in the side view of FIG. 8B. The operator may then insert the alignment pin 614 into the first alignment hole 600 in the top plate to determine if the barrel end 615 of the alignment pin 614 is aligned with the alignment hole 616 in the robot blade.

If the robot blade alignment hole 616 is properly aligned with the end 615 of the alignment pin 614 and hence the cassette alignment hole 600, the end 615 of the alignment pin 614 will pass through the blade alignment hole 616 as shown in the cassette front view of FIG. 8C and the cassette top view of FIG. 8A. In the illustrated embodiment, the first alignment hole 600 and the blade alignment hole 616, each has a diameter of ⅛″ but may of course have other dimensions and placements, depending upon the application. Furthermore, the alignment surfaces of the metrology cassette, the alignment pin and the robot blade may have a variety of shapes and positions other than the illustrated cylindrical shapes.

To align the blade alignment hole 616 to the alignment pin end 615, the operator may command the processing system controller to make small adjustments in the current settings of the blade extension count to extend or withdraw the blade, and in the blade rotation count to rotate the blade either clockwise or counter-clockwise as needed. When the operator has adjusted the robot blade to the proper Extension / Rotation position, the alignment pin end 615 should drop through the alignment hole 616 in the robot blade easily with no help or force from the operator.

The operator can record both the readings of the “Blade Extension Step Count” and the “Blade Rotation Step Count” on the Blade Extension Rotation worksheet 820 (FIG. 12) in windows provided for that purpose on the computer. As an example, the value 17080 has been entered in an upper left window 822 for the “Extension Step Count.” Similarly, the value −5880 has been entered in an upper right window 824 of the “Rotation Step Count.”

As is apparent from FIGS. 7B and 8B, the platform support surface, or base plane 220 has an imaginary axis of rotation 634 extending orthogonally from the base plane 220. The cassette 410 is adapted to be positioned on the platform 200 so that the axis of rotation 634 extends through the first alignment hole 600 and through the blade alignment hole 616 when the robot blade is inserted and properly positioned. Thus when properly aligned in this position, the robot blade 206 and the cassette 410 (and therefore the cassette handler 208 on which the cassette is mounted) are aligned to the wafer centerline. However, it may additionally be desirable to rotationally align the cassette 410 (and therefore the cassette handler 208) about the axis of rotation 634 to the linear travel of the robot blade 206.

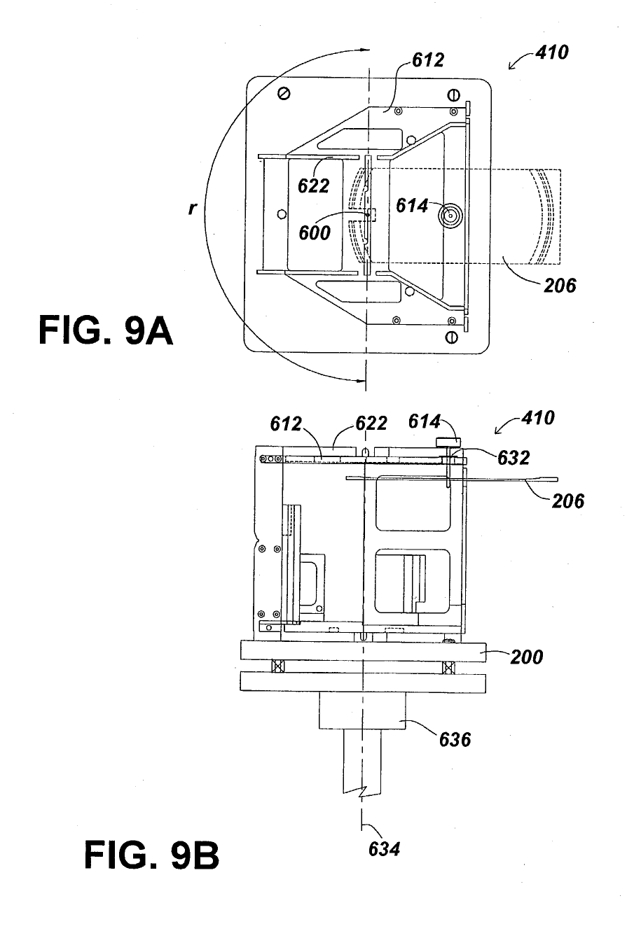

To accomplish this alignment, the operator next causes the processing system controller to retract the robot blade 206 from the Drop Position/Pick Position to an intermediate position, as shown in FIGS. 9A and 9B, between the Drop Position/Pick Position and the fully retracted position. In the illustrated embodiment, the blade 206 is retracted 3.375 inches for 200 mm wafer cassettes and 2.909 inches for 150 mm wafer cassettes. However, other distances may be used as well without departing from the scope of the inventions.

The operator may then insert the pin 614 into the second alignment hole 632 in the top plate 612 to determine if the barrel end 615 of the alignment pin 614 is aligned with the alignment hole 616 in the robot blade. The second alignment hole 632 is defined by a second circular or cylindrical inner alignment surface of the top plate 612 which permits the alignment pin 614 to be inserted through the hole 632 and through the blade alignment hole 616 in the robot blade 206 when the blade is properly aligned with the alignment pin 614. Thus the end 615 of the alignment pin 614 will pass through the second cassette alignment hole 632 and the blade alignment hole 616 as shown in the cassette side view of FIG. 9B and the cassette top view of FIG. 9A.

To align to the blade alignment hole 616 to the alignment pin end 615, the operator may release the clamp screws (not shown) on the cassette handler elevator clamp collar 636, and then rotate the handler platform 200. This in turn will cause the cassette 410 to rotate about the axis of rotation 634 as illustrated by the vector r in FIG. 9A. When the operator has adjusted the platform 200 and the cassette 410 to the proper rotational position, the alignment pin end 615 should drop through the alignment hole 616 in the robot blade easily with no help or force from the operator. The operator may then tighten the clamp screws on the elevator clamp collar 636 and remove the alignment pin 614. At this point, the rotational alignment of the cassette handler 208 should be aligned to the linear travel of the robot blade 206.

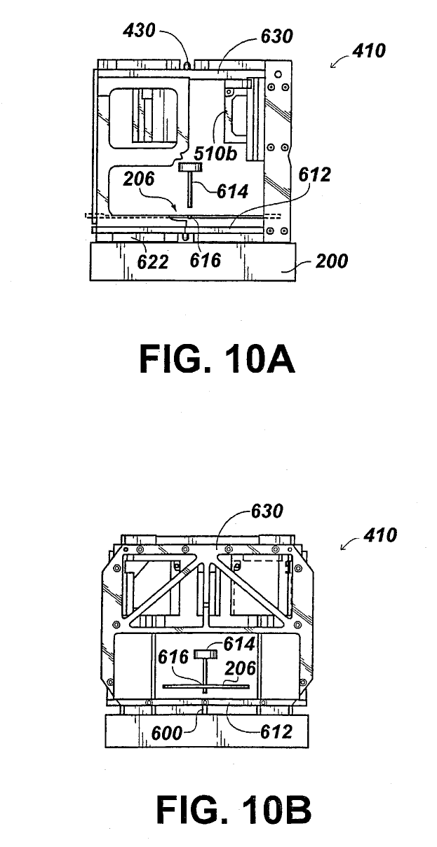

In accordance with another aspect of the illustrated embodiments, the top plate 612 of the metrology cassette 400 has cassette alignment and registration surfaces including the top H-bar 622 in the same manner as the base plate 630. This permits the metrology cassette 400 to be inverted so that the top plate 612 engages and aligns to the handler platform 200 as shown in FIG. 10A. As a consequence, the alignment hole 600 in the plate 612 of the metrology cassette 400 may be used to align the robot blade rotation and extension positions when the blade is in a substantially lower slot base position such as slot base #2.

Accordingly, after inverting and reseating the metrology cassette 400 as shown in FIG. 10A, the operator causes the processing system controller to move the loadlock “LLA” cassette handler to slot base #24 and then extend the robot blade to the Drop Position/Pick Position of loadlock “LLA”. The operator may then insert the alignment pin 614 into the robot blade alignment hole 616 as shown in FIG. 10B to determine if the barrel end of the alignment pin 614 is aligned with the alignment hole 600 of the cassette plate 612. If the alignment blade alignment hole 616 is properly aligned with the cassette alignment hole 600, the end 615 of the alignment pin 614 will pass through the plate alignment hole 600. Again, when the operator has adjusted the robot blade to the proper Extension/Rotation position, the alignment pin end 615 should drop through the alignment hole 600 in the cassette plate easily with no help or force from the operator.

The operator can record both the readings of the “Blade Extension Step Count” and the “Blade Rotation Step Count” for slot base #2 on the Blade Extension Rotation worksheet 820 (FIG. 12) in windows provided for that purpose on the computer. As an example, the value 17100 has been entered in a lower left window 826 for the “Extension Step Count.” Similarly, the value −5890 has been entered in a lower right window 828 for the “Rotation Step Count.”

The values of the rotation and extension step counts for either or both of the slot base positions may be entered into the processing system controller for controlling the movements of the robot blade to set the blade extension and rotation counts for the blade dropoff/pickup position for the loadlock chamber. Alternatively, and in accordance with another aspect of the illustrated embodiments, the cassette alignment tool system 400 can automatically calculate and display an average of the Extension Step Count from both readings taken at slot base #24 and slot base #2, respectively, and also an average of the Rotation Step Count from both readings taken at slot base #24 and slot base #2, respectively.

In the illustrated embodiment, these averages are displayed as bold numbers at the bottom of the Blade Extension and Rotation screen 820 in the boxes 830 and 832, labeled Calculated Ideal EXTENSION Count and Calculated Ideal ROTATION Count, respectively. For example, FIG. 12 shows a Calculated Ideal EXTENSION Count number to be 17090 and a Calculated Ideal ROTATION Count number to be −5885. These calculated average values may be input into the processing system controller for controlling the movements of the robot blade to set the blade extension and rotation counts for the blade dropoff/pickup position for the loadlock chamber.

The metrology cassette 410 may be used with a variety of robots, robot blades, elevators, system controllers and cassettes other than those depicted and described to align and set a variety of blade/cassette positions other than those described. Moreover, it should be appreciated that while the illustrated embodiment comprises two alignment surfaces defining two apertures in the top plate 612 of the cassette 410 and one alignment surface defining one aperture in the robot blade 206, other combinations may be employed. For example, a plurality of apertures may be disposed in the robot blade and only one aperture in the cassette top plate. Alternatively, a plurality of apertures may be placed in both the cassette top plate as well as the robot blade. Because it is contemplated that the top plate or the robot blade may have one or more apertures, this shall be referred to herein as “aperture means.”

Rather than the use of an alignment plug, pin or member, alternative embodiments may employ a light source and light detector arrangement. Examples of light sources can include lasers, incandescent bulbs, fluorescent bulbs and fiber optic sources. Because it is contemplated that one or more light sources and one or more light detectors may be employed, this shall be referred to herein as “light source means” and “light detector means,” respectively. The metrology cassette frame can define a frame aperture means adapted to permit the passage of light from the light source means through the frame aperture means. Light detector means can be adapted to detect the passage of light from the light source means through the frame aperture means and the blade aperture means when the robot blade is positioned in a first predetermined position. The light detector means can be further adapted to detect the passage of light from the light source means through the frame aperture means and the blade aperture means when the robot blade is positioned in a second predetermined position.

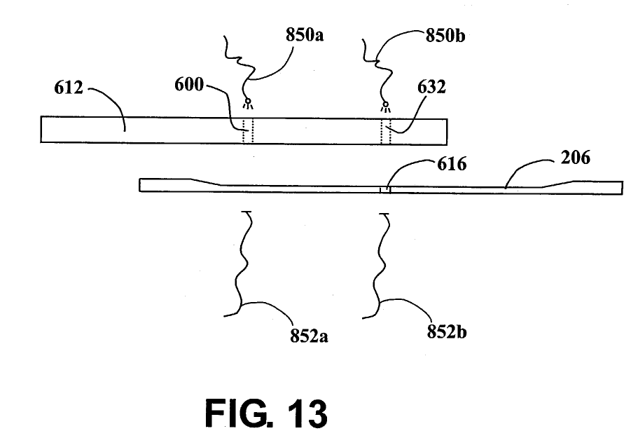

In FIG. 13 two fiber optic light sources 850a, 850b are disposed above the first and second alignment holes 600, 632 of the top plate 612. Situated on the opposite side of the top plate 612 are two fiber optic light detectors 852a, 852b which are aligned with the alignment holes 600, 632. Thus when the alignment holes in the cassette and the robot blade are in proper alignment, such as for example the second alignment hole 632 and the blade alignment hole 616 in FIG. 13, a beam of light can travel from the light source 850b through the aligned holes whereupon the beam will be received by the light detector 852b.

### Metrology Cassette 410 Mechanical Construction and Features

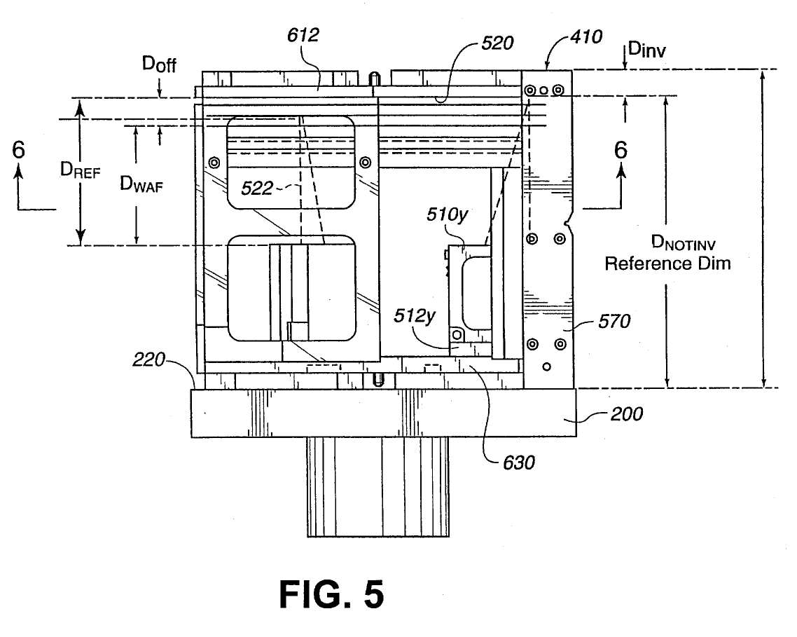

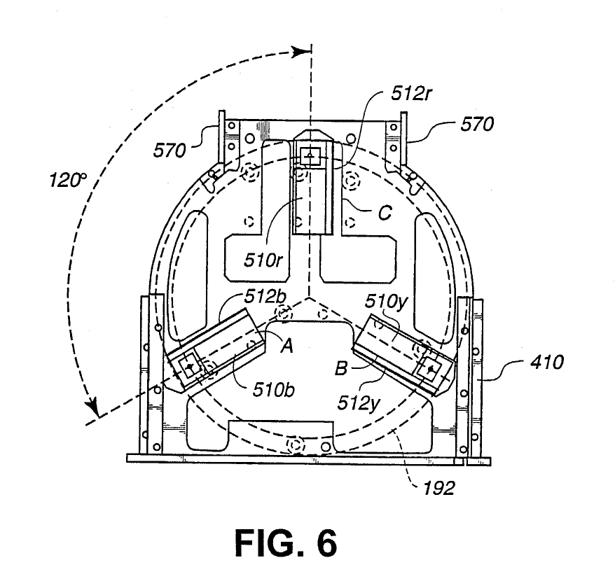

As previously described, the cassette 410 can be used for aligning a cassette handler to a movable robot blade for carrying a workpiece in a workpiece handling system. As best seen in FIGS. 5 and 6, other aspects of the cassette 410 include the distance measurement device 500 comprising three laser sensors A, B and C, each of which includes a laser head 510b, 510r or 510y, which is clamped in a mounting 512b, 512r or 512y, respectively, carried by the metrology cassette 410. The mountings 512b, 512r and 512y are preferably color coded and mechanically keyed to reduce or eliminate inadvertent exchanges or misplacements of the laser heads in the mountings. Thus, the mountings 512b, 512r and 512y may be color coded blue, red and yellow, respectively, for example.

In the illustrated embodiment, the distance sensors are laser sensors manufactured by NaiS/Matshshita/Panasonic (Japan), model ANR12821 (high power) or ANR11821 (low power). This particular laser sensor operates upon a perpendicular beam, scattered reflection triangulation using a position sensing diode array. The light source (laser) impinges upon the target perpendicular to the surface of the target, preferably within a relatively small angle.

The surface preferably provides a diffuse reflection that is visible to the sensing device over a relatively wide angle. The field of view of the sensing device is focused upon a linear optical sensor, the output of which is interpreted to determine the displacement of the target surface within the field of view. The geometry of the light path therefore forms a right triangle with light from the light source traveling along the vertical edge and reflected light of the return path traveling along the diagonal. The distance between the sensor and the target may then be calculated using the Pythagorean theorem.

In the embodiment of FIG. 6, the heads 510b, 510r and 510y of the laser sensors are positioned in an equilateral triangular placement which facilitates a three point plane distance determination for measuring the height of a surface such as a wafer surface.

The metrology cassette or fixture 410 of the illustrated embodiment is a precision frame assembly emulating the size and mounting interfaces of a wide range of plastic wafer cassettes. The variable attributes of individual cassettes such as slot positions and spacing can be defined in software instead of requiring physical changes to the metrology cassette 410.

Other aspects of the metrology cassette 410 include the reference surface 520 (FIG. 5) which is used as a “zero” point by the laser sensors housed within the cassette 410. In that the height of the reference surface 520 is known, the true height of the wafer may be easily calculated using the measured offset from the reference height. Since this height typically does not appreciably vary with time or temperature (normal extremes), the lasers can be “soft zeroed” using the offset measured from the reference surface 520.

The laser sensors of the illustrated embodiment have a linear measurement range of 3.149″+/−0.7874″ (80.00 mm+/−20.00 mm). Because of the thickness of the base plate 630 (FIG. 5) and the height of the laser head mounting brackets 512 (FIGS. 5 and 6), the linear measurement range of the laser heads covers slots 1-4 and 22-25 for most styles of cassettes. On some systems, the robot blade wrist may interfere with the top and bottom plates, limiting the mechanically usable slot range to 2-4 and 22-24. These ranges as well as other sizes, characteristics and values are provided as examples and can vary, depending upon the type of distance sensor selected and the intended application.

The laser head supports on the mounting brackets 512 may be pin-located and color coded in their positions, and are preferably not mechanically interchangeable so as to prevent setup errors. The laser heads may be located in a variety of patterns including the illustrated triangular pattern (FIG. 6) which facilitates height measurement operations. The particular pattern selected may vary depending upon the application.

The mechanical framework of the metrology cassette 410 serves a number of functions in addition to enclosing and supporting the laser sensors. One such function of the fixture is the precise positioning of the reference surface 520 for the laser sensors. It is preferably flat, parallel to the base, and precisely at a defined reference height. In the illustrated embodiment, this reference height of the reference surface 520 is the height marked D_{NOTiNV} which is the height of the reference surface above the cassette handler platform base plane 220 when the metrology cassette is in the noninverted position as shown in FIG. 5. It is preferred that this dimension be tightly controlled to increase the accuracy of the height measurements. The tolerance specifications for this surface in the illustrated embodiment are as follows:

Flatness: +/−0.002″ (+/−0.05 mm) overall

Parallelism: +/−0.002″ (+/−0.05 mm)

Height D_{NOTINV} (referenced to base plane 220 of platform 200):

D_{NOTINV}+/−0.002″ (181.04 mm+/−0.05 mm)

As set forth above, another preferred construction feature is the thickness of the top plate 612 from its topmost surface in the noninverted orientation to the reference surface 520. This thickness defines another reference height of the reference surface 520. This second reference height is the height marked D_{INV} which is the height of the reference surface 520 above the cassette handler platform base plane 220 when the metrology cassette is in the inverted position as shown in FIG. 10B. Its specification in the illustrated embodiment is:

Thickness: D_{INV}+/−0.002″ (+/−0.05 mm)

Adding the two reference heights to one another, the overall height of the metrology cassette 410 is:

Total Height: D_{INV}+D_{NOTINV}+/−0.004″ (+/−0.10 mm)

Furthermore, the finish of the reference surface 520 is preferably compatible with the laser sensors. In the illustrated embodiment, the reference surface 520 is lapped, ground and “vapor honed” to a matte finish (0.000016″ (0.00041 mm) RMS) to within +/−0.001″ (+/−0.0255 mm) flatness across its entire working surface. The reference surface is also hard anodized to deposit a layer which provides a surface which is similar to a white unglazed ceramic.

FIG. 7A shows a top view of the top plate 612 of the metrology cassette 410. The top plate 612 has base plane surfaces which engage the base plane 220 of the cassette handler platform 200. Those cassette base plane surfaces and other topmost surface features of the top plate are preferably themselves flat within 0.002″ (0.05 mm) for the fixture 410 to fit into the system's cassette handler nest in the cassette noninverted position without rocking. These features also may have tight tolerances applied to them so that the assembly will not have excessive lateral movements during its use. The cassette base plane surfaces and other surface features of the bottom plate 630 (FIG. 5) may be similarly constructed to facilitate fitting into the system's cassette handler nest in the cassette noninverted position.

As best seen in FIGS. 5 and 6, the metrology cassette 410 has side rails 570 which support and locate the reference top plate 612. In addition the side rails 570 maintain the “squareness” of the shape of the metrology cassette. A webbing 572 (FIG. 8C) in the front (wafer entry side) of the fixture 410 is provided to increase its stability and strength. These pieces also serve as registration surfaces for systems such as the P5000 Ergonomic Cassette Handler (sold by Applied Materials, Inc.) that rely upon certain upper-portion features for location.

In the illustrated embodiment the components of the fixture 410 are preferably located and assembled with dowel pins 580 (FIG. 8C) to ensure that the basic accuracy of the fixture is not compromised under normal operating conditions. As previously discussed, the top surface of the top plate 612 and the bottom surface of the bottom plate 630 are both machined to imitate the bottom features of common wafer cassettes. Thus, the exterior of the metrology cassettes emulates the bottom surface features, wafer cassette vertical profile, sidebars, “H” bar, etc. This allows it to be inserted into most systems with the reference plate on top or bottom.

This is very useful when characterizing leadscrews and determining slot spacing. In addition, this widens the applicability of the fixture because it allows upper and lower slot alignments to be performed. It also allows topside and bottom side rotations and extensions to be determined. These features include the top H-bar 622 as shown in FIG. 7A. Variations and compromises from the features of individual cassettes can be made so as to accommodate the widest possible range of systems and cassettes. For example, by choosing the smallest size of the registration surfaces within the permitted range of tolerances of the cassettes to be emulated, the number of cassettes which can be emulated by a single tool 410 may be increased.

The metrology cassette 410 of the illustrated embodiment is lightweight, preferably approximating the mass of a production wafer cassette full of wafers. It should be noted that the precise location of the fixture in the horizontal plane (X-Y) is significant primarily in the extension/rotation alignment setups because the top plate 612 contains the two precision alignment apertures or holes 600 and 632 for the extension and rotation determinations.

The dimensions, ranges, shapes, materials, sizes, characteristics, finishes, processes and values of the metrology cassette construction are provided as examples and can vary, depending upon the intended application. Other features and uses of the metrology cassette are disclosed in U.S. Patent Application No. 09/294,301, filed Apr. 19, 1999, and U.S. Patent Application No. 09/881,854, filed Jun. 13, 2001, both of which are incorporated herein by reference and are assigned to a common assignee as the present application.

While the description above refers to particular embodiments of the present invention, it will be understood that many modifications may be made without departing from the spirit thereof. The claims are intended to cover such modifications as would fall within the true scope and spirit of the present invention. The presently disclosed embodiments are therefore to be considered in all respects as illustrative and not restrictive, the scope of the invention being indicated by the claims rather than the foregoing description, and all changes which come within the meaning and range of equivalency of the claims are therefore intended to be embraced therein.

What is claimed is:

1. An apparatus for aligning a cassette handler to a movable robot blade for carrying a workpiece in a workpiece handling system wherein the cassette handler has a support surface for supporting a workpiece cassette having a plurality of slots for carrying workpieces, the apparatus comprising:
an alignment member; and
a frame adapted to be supported by the cassette handler support surface in a first orientation of the frame relative to the handler support surface, the frame having a first frame alignment surface adapted to receive the alignment member, the first frame alignment surface defining a first predetermined robot blade position;
wherein the robot blade has a blade alignment surface adapted to receive the alignment member when the robot blade is positioned in the first predetermined position and when the member is received by the first frame alignment surface.

2. The apparatus of claim 1 wherein the alignment member comprises a pin, wherein the first frame alignment surface defines a first aperture adapted to receive the pin and wherein the blade alignment surface defines a blade aperture adapted to receive the pin.

3. The apparatus of claim 1 wherein the workpiece handling system includes a robot for rotating and extending the robot blade, the first predetermined robot blade position comprising a first robot blade extension position and a first robot blade rotation position.

4. The apparatus of claim 3 wherein the first predetermined robot blade position is a robot blade workpiece drop-off position.

5. The apparatus of claim 4 wherein the first predetermined robot blade position is at a first height of the blade relative to the handler support surface, the first height corresponding to the height of the blade at a slot base position.

6. The apparatus of claim 1 wherein the first predetermined robot blade position is at a first height of the robot blade relative to the handler support surface, the frame being adapted to be supported by the cassette handler support surface in a second orientation of the frame relative to the handler support surface, the first frame alignment surface defining a second predetermined robot blade position when the frame is in the second orientation, wherein the robot blade is positioned in the second predetermined position when the member is received by the alignment surface of the robot blade and by the first frame alignment surface in the second orientation.

7. The apparatus of claim 6 wherein the second predetermined robot blade position is at a second height of the blade relative to the handler support surface, the second height corresponding to the height of the blade at a slot base position.

8. The apparatus of claim 1 wherein the frame further has a second frame alignment surface adapted to receive the alignment member, the second frame alignment surface defining a second predetermined robot blade position;
wherein the blade alignment surface being further adapted to receive the alignment member when the robot blade is positioned in the second predetermined position and when the member is received by the second frame alignment surface.

9. The apparatus of claim 8 wherein the alignment member comprises a pin, wherein the first frame alignment surface defines a first aperture, the second frame alignment surface defines a second aperture, and wherein the blade alignment surface defines a blade aperture, the first, second and blade apertures being adapted to receive the pin.

10. The apparatus of claim 9 wherein the cassette handler support surface has an axis of rotation extending orthogonally from the support surface and wherein the frame is adapted to be supported by the support surface so that the axis of rotation extends through one of the first and the second apertures.

11. The apparatus of claim 9 wherein the second aperture is 1.75 inches to 4.0 inches apart from the first aperture.

12. The apparatus of claim 8 wherein the workpiece handling system includes a robot for rotating and extending the robot blade, the first predetermined robot blade position comprising a first robot blade extension position and a first robot blade rotation position, the second predetermined robot blade position comprising a second robot blade extension position.

13. The apparatus of claim 12 wherein the first predetermined robot blade position is a robot blade workpiece drop-off position.

14. The apparatus of claim 12 wherein the second predetermined robot blade position is 1.75 inches to 4.0 inches apart from the first predetermined robot blade position.

15. An apparatus for aligning a cassette handler to a movable robot blade for carrying a workpiece in a workpiece handling system, wherein the robot blade defines a blade aperture means and wherein the cassette handler has a support surface for supporting a workpiece cassette, the apparatus comprising:
an alignment member; and
a frame adapted to be supported by the cassette handler support surface, the frame defining a frame aperture means adapted to receive the alignment member;
wherein the blade aperture means is adapted to receive the alignment member when the robot blade is positioned in a first predetermined position and when the alignment member is received by the frame aperture means; and
wherein the blade aperture means is further adapted to receive the alignment member when the robot blade is positioned in a second predetermined position and when the alignment member is received by the frame aperture means.

16. The apparatus of claim 15 wherein the cassette handler support surface has an axis of rotation extending orthogonally from the support surface and wherein the frame is adapted to be supported by the support surface so that the axis of rotation extends through the frame aperture means.

17. An apparatus for aligning a cassette handler to a movable robot blade for carrying a workpiece in a workpiece handling system wherein the cassette handler has a support surface for supporting a workpiece cassette, and wherein the robot blade defines a blade aperture means, the apparatus comprising:
a light source means;
a frame adapted to be supported by the cassette handler support surface, the frame defining a frame aperture means adapted to permit the passage of light from the light source means through the frame aperture means; and
a light detector means adapted to detect the passage of light from the light source means through the frame aperture means and the blade aperture means when the robot blade is positioned in a first predetermined position.

18. The apparatus of claim 17 wherein the workpiece handling system includes a robot for rotating and extending the robot blade, the first predetermined robot blade position comprising a first robot blade extension position and a first robot blade rotation position.

19. The apparatus of claim 18 wherein the first predetermined robot blade position is a robot blade workpiece drop-off position.

20. The apparatus of claim 17 wherein the light detector means is further adapted to detect the passage of light from the light source means through the frame aperture means and the blade aperture means when the robot blade is positioned in a second predetermined position.

21. The apparatus of claim 20 wherein the workpiece handling system includes a robot for rotating and extending the robot blade, the first predetermined robot blade position comprising a first robot blade extension position and a first robot blade rotation position, the second predetermined robot blade position comprising a second robot blade extension position.

22. The apparatus of claim 21 wherein the first predetermined robot blade position is a robot blade workpiece drop-off position.

23. The apparatus of claim 20 wherein the cassette handler support surface has an axis of rotation extending orthogonally from the support surface and wherein the frame is adapted to be supported by the support surface so that the axis of rotation extends through the frame aperture means.

24. A method of aligning a cassette handler to a movable robot blade for carrying a workpiece in a workpiece handling system wherein the cassette handler has a support surface for supporting a workpiece cassette having a plurality of slots for carrying workpieces, the method comprising:
placing a frame on the cassette handler support surface in a first orientation of the frame relative to the handler support surface, the frame having a first frame alignment surface defining a first predetermined robot blade position, the first frame alignment surface being adapted to receive an alignment member;
positioning the robot blade in a first location relative to the frame at a first height of the blade relative to the handler support surface wherein the robot blade has a blade alignment surface adapted to receive the alignment member; and
conducting a first test of the alignment of the robot blade relative to the frame, the first test comprising placing the alignment member in engagement with at least one of the first frame alignment surface and the blade alignment surface;
wherein the robot blade is positioned in the first predetermined robot blade position at the first height when the alignment member is received by both the first frame alignment surface and the robot blade alignment surface.

25. The method of claim 24 wherein the alignment member comprises a pin, the first frame alignment surface defines a first frame aperture adapted to receive the pin, and the blade alignment surface defines a blade aperture adapted to receive the pin.

26. The method of claim 24 wherein the workpiece handling system includes a robot for rotating and extending the robot blade, the first predetermined robot blade position comprising a first robot blade extension position and a first robot blade rotation position.

27. The method of claim 26 wherein the first predetermined robot blade position is a robot blade workpiece drop-off position.

28. The method of claim 27 wherein the first height corresponds to the height of the robot blade at a slot base position.

29. The method of claim 24 further comprising:
placing the frame on the cassette handler support surface in a second orientation of the frame relative to the handler support surface;
positioning the robot blade relative to the frame at a second height of the blade relative to the handler support surface; and
conducting a second test of the alignment of the robot blade relative to the frame, the second test comprising placing the alignment member in engagement with at least one of the first frame alignment surface and the blade alignment surface;
wherein the robot blade is positioned in a second predetermined robot blade position at the second height when the alignment member is received by both the first frame alignment surface and the robot blade alignment surface.

30. The method of claim 29 wherein the second robot blade height corresponds to the height of the blade at a slot base position.

31. The method of claim 24 wherein the frame has a second frame alignment surface defining a second predetermined robot blade position, the second frame alignment surface being adapted to receive the alignment member, the method further comprising:
positioning the robot blade in a second location relative to the frame; and
conducting a second test of the alignment of the robot blade relative to the frame, the second test comprising placing the alignment member in engagement with at least one of the second frame alignment surface and the blade alignment surface;
wherein the robot blade is positioned in the second predetermined robot blade position when the alignment member is received by both the second frame alignment surface and the robot blade alignment surface.

32. The method of claim 31 wherein the cassette handler support surface has an axis of rotation extending orthogonally from the support surface, the method further comprising rotating the cassette handler support surface about the axis of rotation.

33. The method of claim 31 wherein the alignment member comprises a pin, wherein the first frame alignment surface defines a first frame aperture, the second frame alignment surface defines a second frame aperture, and the blade alignment surface defines a blade aperture, and wherein the first frame aperture, the second frame aperture and the blade aperture are adapted to receive the pin.

34. The method of claim 33 wherein the cassette handler support surface has an axis of rotation extending orthogonally from the support surface, wherein the frame is adapted to be supported by the support surface so that the axis of rotation extends through one of the first frame aperture and the second frame aperture.

35. The method of claim 33 wherein the second frame aperture is 1.75 inches to 4.0 inches apart from the first frame aperture.

36. The method of claim 34 further comprising rotating the cassette handler support surface about the axis of rotation.

37. The method of claim 31 wherein the workpiece handling system includes a robot for rotating and extending the robot blade, the first predetermined robot blade position comprising a first robot blade extension position and a first robot blade rotation position, the second predetermined robot blade position comprising a second robot blade extension position.

38. The method of claim 37 wherein the first predetermined robot blade position is a robot blade workpiece drop-off position.

39. The method of claim 37 wherein the second predetermined robot blade position is 1.75 inches to 4.0 inches apart from the first predetermined robot blade position.

40. A method of aligning a cassette handler to a movable robot blade for carrying a workpiece in a workpiece handling system wherein the cassette handler has a support surface for supporting a workpiece cassette having a plurality of slots for carrying workpieces and wherein the support surface has an axis of rotation extending orthogonally from the support surface, the method comprising:
placing a frame on the cassette handler support surface, the frame having a first frame aperture and a second frame aperture, the first frame aperture defining a first predetermined robot blade position, the second frame aperture defining a second predetermined robot blade position, both the first and second frame apertures being adapted to receive an alignment member;
positioning the robot blade in a first location relative to the frame at a first height of the blade relative to the handler support surface wherein the robot blade has a blade aperture adapted to receive the alignment member;
conducting a first test of the alignment of the robot blade relative to the frame, the first test comprising placing the alignment member into at least one of the first frame aperture and the blade aperture;
wherein the robot blade is positioned in the first predetermined robot blade position at the first height when the alignment member is received by both the first frame aperture and the robot blade aperture;
positioning the robot blade in a second location relative to the frame;
rotating the cassette handler support surface about the support surface axis of rotation; and
conducting a second test of the alignment of the robot blade relative to the frame, the second test comprising placing the alignment member into at least one of the second frame aperture and the blade aperture;
wherein the robot blade is positioned in the second predetermined robot blade position when the alignment member is received by both the second frame aperture and the robot blade aperture.

41. An apparatus for aligning a cassette handler to a movable robot blade for carrying a workpiece in a workpiece handling system wherein the cassette handler has a support surface for supporting a workpiece cassette and wherein the robot blade defines a blade aperture means, the apparatus comprising:
a frame adapted to be supported by the cassette handler support surface in a first orientation of the frame relative to the handler support surface, the frame defining a frame aperture means;
means for testing the alignment of the robot blade relative to the frame wherein the frame aperture means is aligned with the blade aperture means when the robot blade is positioned in a first predetermined position.

42. The apparatus of claim 41 wherein the workpiece handling system includes a robot for rotating and extending the robot blade, the first predetermined robot blade position comprising a first robot blade extension position and a first robot blade rotation position.

43. The apparatus of claim 42 wherein the first predetermined robot blade position is a robot blade workpiece drop-off position.

44. The apparatus of claim 41 wherein the frame is further adapted to be supported by the cassette handler support surface in a second orientation of the frame relative to the handler support surface, and wherein the testing means further includes testing the alignment of the robot blade relative to the frame when the frame is in the second orientation wherein the frame aperture means is aligned with the blade aperture means when the robot blade is positioned in a second predetermined position.

45. The apparatus of claim 41 wherein the means for testing the alignment of the robot blade relative to the frame further comprises the frame aperture means being aligned with the blade aperture means when the robot blade is positioned in a second predetermined position.

46. The apparatus of claim 45 wherein the cassette handler support surface has an axis of rotation extending orthogonally from the support surface and wherein the frame is adapted to be supported by the support surface so that the axis of rotation extends through the frame aperture means.

47. The apparatus of claim 45 wherein the workpiece handling system includes a robot for rotating and extending the robot blade, the first predetermined robot blade position comprising a first robot blade extension position and a first robot blade rotation position, the second predetermined robot blade position comprising a second robot blade extension position.

48. The apparatus of claim 47 wherein the first predetermined robot blade position is a robot blade workpiece drop-off position.

49. The apparatus of claim 45 wherein the second predetermined robot blade position is 1.75 inches to 4.0 inches apart from the first predetermined robot blade position.
